(19) United States
(12) Patent Application Publication
(10) Pub. No.: US 2005/0107550 A1
(43) Pub. Date: May 19, 2005

(54) Elastic articles prepared from extrudable elastomeric compositions

(76) Inventor: Purushottam Das Agrawal, Akron, OH (US)

Correspondence Address: WALKER & JOCKE, L.P.A., 231 SOUTH BROADWAY STREET, MEDINA, OH, 44256, US

(21) Appl. No.: 10/713,870

(22) Filed: Nov. 14, 2003

(51) Int. Cl. C08G 71/04

(52) U.S. Cl. 525/452

(57) ABSTRACT

This invention relates to an elastomeric composition for use in extruding elastic articles of manufacture which comprises thermoplastic polyurethanes (TPU), polyolefins, styrene-olefins polymers, ethylene-vinyl acetate polymers, maleic anhydride-olefin polymers, and phenolic resins. The elastomeric compositions are particularly useful in extruding these compositions for the preparation of sheets, fibers and fibrous nonwoven fabrics in an extruder attached to an extensional flow mixer.

### FIELD OF INVENTION

This invention relates to extrudable elastomeric compositions, the method of extruding said compositions, and to various elastic articles of manufacture prepared from the extruded compositions.

### BACKGROUND OF THE INVENTION

There is a need to develop an elastomeric composition having improved tension set-resistance such that the dimensions of an elastic article will be restored after extension has been applied and is released. It is important for the elastic article to return substantially to its original form after deformation. More specifically, there is need for extrudable elastomeric compositions that can be easily extruded to form elastic sheets, fibers, and non-woven fabrics having high-recoverable energy. These materials e.g. fibers or elastic sheets are particularly useful in the manufacture of various articles including for example, pants, dresses, sporting goods such as sweat suits, diapers, liners, upholstery, and numerous other articles requiring elasticity. These shaped articles may be formed from elastomers by extrusion, injection molding or blown film.

### SUMMARY OF THE INVENTION

This invention relates to extrudable elastomeric compositions, the method of extruding said elastomeric compositions and to the manufacture of various elastic articles including fibers, sheets, fibrous non-woven fabrics and the like. The extrudable elastomeric compositions of this invention comprises from about 20 to 50 parts by weight of a polymer selected from the group consisting of a thermoplastic polyurethane (TPU) and a polyolefin, 20 to 50 parts by weight of a styrene-olefin copolymer, 5.0 to 40 parts by weight of an ethylene-vinyl acetate copolymer, 1.0 to 10 parts by weight of a maleic anhydride-olefin copolymer and 0.0 to 3.0 parts by weight of a phenolic resin. The extrudable elastomeric compositions of this invention are materials that exhibit both thermoplastic and elastomeric properties, but have properties more like elastomers.

The elastic articles of this invention are prepared by using an Extensional Flow Mixer (EFM™) attached to a single-screw or twin-screw extruder for injection molding, blow molding, or extrusion. In this device (EFM), the elastomeric compositions are hydrodynamically mixed by flowing through a series of convergent and divergent regions of increasing intensity such that very efficient dispersion and distribution of the elastomers can be achieved.

Accordingly, it is an object of this invention to provide an elastomeric composition capable of being extruded injection molded or films into various elastic articles.

It is another object of this invention to provide a method of extruding the elastomeric compositions in an extruder having an extensional flow mixer attached thereto.

It is a further object of this invention to provide an elastomeric composition for extrusion into an elastic article that returns to its original dimension after pressure that has been applied is released.

These and other object of this invention will become more apparent from a further and more detailed description of the invention.

### DETAILED DESCRIPTION OF THE INVENTION

This invention is directed to elastomeric compositions, to the method of extruding said compositions in an extruder having attached thereto an Extensional Flow Mixer, and to the elastic articles having a set percent of about 1.0 prepared from said elastomeric compositions. The elastomeric compositions for extrusion to form the elastic articles include, for example, fibers, sheets, and fibrous non-woven fabrics. The composition comprises from about 20 to 50, and preferably 35 to 45 parts by weight of a polymer selected from the group consisting of a thermoplastic polyurethane and a polyolefin, 20 to 50, and preferably 35 to 45 parts by weight of a styrene-olefin copolymer, 5.0 to 40 and preferably 20 to 20 parts by weight of an ethylene-vinyl acetate copolymer, 1.0 to 10 and preferably 4 to 6.0 parts by weight of a maleic anhydride-olefin copolymer, and 0.0 to 3.0 and preferably 0.1 to 2.0 parts by weight of a phenolic resin.

In preparing the extruded elastic articles of this invention, it is preferred to use an Extensional Flow Mixer attached to the extruder. The EFM™ is from Extensional Flow Mixer Inc. The mixing process is important in polymer processing, where it is common to blend different polymers, additives and fillers to achieve certain features of the processing and products. Even a single-phase polymer has a molecular weight distribution of a small amount of cross-linked polymer due to poor production quality. The high molecular weight fraction can also generate “unmelt” or gel particles during processing, for example, during film production. These problems can be avoided by using an EFM™ device wherein the plastic is hydrodynamically mixed by flowing through a series of convergent and divergent regions of increasing intensity so that very efficient dispersive and distributive mixing can be achieved. The EFM device can be attached to any machine capable of pumping molten plastic, such as single-screw (SSE) and twin-screw extruders (TSE), for injection molding, blow molding or extrusion. The SSE is used to produce films, sheets, or pipes and the like. It is also a part of injection and blow molding. Due to the high viscosity, the polymer melt is laminar, composed of distributive and dispersive mixing. The SSE can usually do a good job of distributive mixing by utilizing shear deformation. However, SSE with either static or dynamic mixers based on shear flow can neither offer good dispersive mixing, nor break droplets of the minor phase in a polymeric matrix when the viscosity ratio is above a limiting value.

The principles of EFM are different from conventional static and dynamic mixers, where molten plastic is subjected to basically shear flow. In an EFM, molten plastic is exposed to extensional flows so that distributive mixing is more efficient since the interfacial area is much higher than that in shear flow. Dispersive mixing is much higher than in shear, since the drop deformability in elongation is several times higher than in shear. This is especially good for multiphase plastic systems, such as plastic alloys and blends of immisible plastics, master batches, recycled plastics. Moreover, the energy per unit volume consumed in the EFM is much lower than in shearing mixers.

Preferably, the elastomeric compositions or blends of this invention are extruded with the attached EFM device to form elastic articles having a set percent of less than 2.0. For example, an elastic article e.g. fibrous nonwoven fabric can have an elasticity elongation of 100% or more, and an extension to retraction recovery ratio of 98% or more, and the permanent deformation of the article can be less than 2%. The tension set of these articles after 100% elongation is less than 2.0% or 1.0%. The physical properties of these elastic articles can be characterized by the term “set” or “percent set” which is the percentage of deformation of the elastic article measured while the article e.g. fiber or sheet is in a relaxed condition immediately after the article is released from a specified elongation. The term “set at break” is the deformation of the elastic article measured after the article has been elongated to break. The “set” and “set at break” are measured by ASTM D-412. The terms “elastic” and “elastomeric” are used interchangeably to mean materials which, upon application of a biasing force are stretchable, for example, to a stretched, biased length to at least 150 percent or more. That is about one and one half, of its relaxed unbiased length, but can recover substantially to the initial relaxed length or to within 101% of the initial relaxed length after releasing the stretching force. The set % can be measured by the Instron Model 1122 of Universal Testing Machine.

The following are specific examples of the elastomeric compositions of this invention, and the method for preparing elastic articles in an extruder with and without an EFM attachment.

### EXAMPLE I

| | Parts by weight |
|---|---|
| Thermoplastic polyurethane (TPU) | 40.00 |
| (Pellathane 1000-85 A) | |
| Styrene-olefin copolymer (VECTOR 4111) | 40.00 |
| Ethylene-vinyl acetate copolymer | 15.00 |
| (Escorene LD783.64/EVA) | |
| Maleic anhydride-olefin copolymer | 4.50 |
| (EXXELOR VA 1803) | |
| Phenolic resin (SP-1045) | 0.50 |

### EXAMPLE II

| | Parts by weight |
|---|---|
| Thermoplastic polyurethane | 45.00 |
| (Pellathane 2102-80AE) | |
| Styrene-olefin copolymer (VECTOR 4111) | 45.25 |
| Ethylene-vinyl acetate copolymer | 6.00 |
| (Escorene LD783.64/EVA) | |
| Maleic anhydride-olefin copolymer | 3.00 |
| (EXXELOR VA 1803) | |
| Phenolic resin (SP-1045) | 0.75 |

### EXAMPLE III

| | Parts by weight |
|---|---|
| Polyolefin (Engage 8450) | 30.00 |
| Styrene-olefin copolymer (VECTOR 4111) | 25.00 |
| Ethylene-vinyl acetate copolymer | 38.00 |
| (Excorene LD783.64/EVA) | |
| Maleic anhydride-olefin copolymer | 3.00 |
| (EXXELOR VA 1803) | |
| Phenolic resin (SP-1045) | 2.00 |

### Physical Properties

### EXAMPLE I (WITHOUT EFM EXTRUDER ATTACHMENT)

| | |
|---|---|
| Tensile strength | 421 psi |
| Elongation | 378% |
| Hardness | 55 A |

### EXAMPLE II (WITH EFM EXTRUDER ATTACHMENT)

| | |
|---|---|
| Tensile strength | 1500 psi |
| Elongation | 1190% |
| Hardness | 52 A |

### EXAMPLE III (WITHOUT EFM EXTRUDER ATTACHMENT)

| | |
|---|---|
| Tensile strength | 430 psi |
| Elongation | 280% |
| Hardness | 62 A |

### EXAMPLE III (WITH EFM EXTRUDER ATTACHMENT)

| | |
|---|---|
| Tensile strength | 1290 psi (8.9 MPa) |
| Elongation | 1550% |
| Hardness | 62 A |

The process conditions of Example II using an extruder with the EFM attachment were as follows:

Extruder (with EFM attachment) 50 mm (2.0 inch)

L/D=30:1.0

Screw−compression ration=3:1

Temperature Profile

| Feed Zone I | Zone II | Zone III | Zone IV | Adapter V |
|---|---|---|---|---|
| 180° C. | 190° C. | 200° C. | 210° C. | 210° C. |

| | |
|---|---|
| Extruder (EFM) = 210° C. | Pelletizing Die = 210° C. |

| | | |
|---|---|---|
| Screw RPM = 35 | GAP = 0.01 inch | Pressure = 2600 psi |

The elastomeric compositions were tumble blended and pelletized. Compression mold plaques or samples were tested and the physical properties were measured with and without the EFM attached to the extruder. The examples were prepared with 300 gram batches in a Brabender extruder at 200° C. for about ten (10) minutes at 100 rpm. The mixtures were removed from the extruder and the physical properties were measured on compression molded plaques. Fibrous non-woven elastic webs are made by extruding blends of the elastomeric polymers through a Brabender extruder and through a melt-blowing die having several extrusion capillaries per lineal inch of the die tip. The elastomeric compositions or blends of this invention comprise class of polymers including homopolymers, copolymers, such as block, graft, random and alternating copolymers, terpolymers, and blends thereof.

In preparing the elastomeric compositions, the preferred polyurethanes (TPU) of this invention are available as polyester or polyether-based thermoplastic polyurethanes obtained from the Dow Chemical Co. under the trademark PELLETHANE. These polyurethanes (2102-80A) have the properties shown in Table 1.

TABLE 1

| PELLETHANE Thermoplastic | | 2102-80A |
|---|---|---|
| Polyurethane Elastomers | | |
| Hardness +/−4 | ASTM D 2240 | |
| Shore A | | 84A |
| Shore D | | |
| Specific Gravity | ASTM D 792 | 1.18 |
| Tensile Modulus | ASTM D 412 | |
| 50% elongation, psi | | 560 |
| 50% elongation, MPa | | 3.9 |
| 100% elongation, psi | | 800 C |
| 100% elongation, MPa | | 5.5 |
| 300% elongation, psi | | 1900 |
| 300% elongation, MPa | | 13.1 |
| Ultimate Tensile Strength | ASTM D 412 | |
| Psi | | 5800 |
| MPa | | 40 |
| Ultimate Elongation, % | ASTM D 412 | 575 |
| Elongation Set | ASTM D 412 | |
| After Break, % | | 50 |
| Tear Strength | ASTM D 624 | |
| Die ° C.° PLI | | 600 |
| Die ° C.° KN/m | | 105 |
| Taber Abrasion, 1000 g wt | | |
| Loss, mg | ASTM D 1044 | |
| CS-17 wheel (finer) | | |
| H-18 wheel | | |
| H-22 wheel (coarser) | | 10 |
| Glass Transition Temperature | ° F. DSC | −40 |
| ° C. | | −40 |
| Molding conditions | ° F. | 390-420 |
| Melt Temperature | ° C. | 199-216 |
| Extrusion conditions | ° F. | 380-410 |
| Optimum temperature | ° C. | 193-210 |

There are other thermoplastic polyurethanes (TPU) useful in the blends of the present invention that are commercially available; see, Rubber Technology, 2^{nd} edition, Chapter 17.

Thermoplastic polyurethanes (TPU) are derived from the reaction of polyester or polyether polyols with diisocyanates and also from the reaction of components with chain-extending agents such as low molecular weight polyols, preferably diols, or with diamines to form urea linkages. Thermoplastic polyurethanes are generally composed of soft segments, for example, polyether or polyester polyols, and hard segments, usually derived from the reaction of the low molecular weight diols and diisocyanates. While thermoplastic polyurethanes with no hard segments can be used, those most useful should contain both soft and hard segments.

The processes for making thermoplastic polyurethanes are well known and include single or multiple step polymerizations. In a single step polymerization, the diisocyanate, polyol and chain extending agent are combined and reacted, whereas in a multiple step process the polyol is first reacted with the diisocyanate to produce a prepolymer which is subsequently reacted with the chain extender to build molecular weight. Processes are disclosed, for example, in U.S. Pat. No. 4,665,126. TPUs are also commercially available from B.F. Goodrich Company under the trademark ESTANE, and from Dow Chemical under the trademark PELLETHANE.

In preparing the elastomeric compositions, the olefin polymers and copolymers are present in the polymeric blends of this invention in amounts ranging from about 20 to 50 parts and in a preferred amount ranging from about 35 to 45 parts by weight. The preferred olefin polymers are ethylene and propylene and the copolymers are the ethylene-octene copolymers obtained from Exxon Mobile Chemicals under the trademark EXXPOL (EXACT 0201). The other olefinic polymers used in preparing these elastomeric blends include ethylene or propylene copolymerized with various lower monomers such as the C₂-C₈ alphaolefins including propylene, butene-1,1-pentene, 4-methyl pentene-1, hexene-1 and octene-1.

The polyolefins utilized in the extrudable compositions are olefins that when blended with the mixture of other elastomeric polymers and subjected to the combination of elevated pressure and temperature conditions are extrudable in blended form. The present invention is not limited to only the polyolefins described herein. The polyolefins described in U.S. Pat. No. 4,789,699 also are useful and are incorporated herein by reference. Generally, the specific purpose of the polyolefin, as described in the prior art such as U.S. Pat. No. 4,789,699 determines the specific polyolefin to be utilized in the present invention.

The styrene-olefin block copolymers of the elastomeric composition are available from The Dow Chemical Co. as VECTOR 4111. VECTOR 4111 is a linear, pure SIS triblock copolymer with narrow molecular weight distribution. The polymer is a low styrene, low modulus copolymer. It contained <1% diblock. It is the softest pure SIS triblock and has the highest elasticity. The polymer has outstanding melt processability and is designed for use in elastomeric films or sheets and is a highly elastomeric polymer. VECTOR 4114 (diblock isoprene-styrene-isoprene-styrene) is a highly elastomeric polymer having a hardness of 25 that will provide a softer composition and can be substituted for VECTOR 4111. Further, a blend of VECTOR 4111 and 4114 will also provide a good elastomeric mixture. The properties of VECTOR 4111 are shown in Table 2.

TABLE 2

| | | | |
|---|---|---|---|
| Properties | Test Method | Unit | Typical Value |

Resin Properties

| | | | |
|---|---|---|---|
| Styrene | Dexco Method | Wt. % | 18 |
| Diblock Content | Dexco Method | Wt. % | <1.0 |
| MFR⁽¹⁾ | ASTM D 1238 | G/10 min | 12 |
| Ash | ASTM D 1416 | Wt. % | 0.3 |
| Physical Properties | | | |
| Tensile Strength⁽²⁾ | ASTM D 412 | PSI | 4000 |
| 300% Modulus⁽²⁾ | ASTM D 412 | PSI | 275 |
| Elongation⁽²⁾ | ASTM D 412 | % | 1200 |
| Hardness⁽³⁾ | ASTM D 2250 | Shore A | 39 |
| Specific Gravity | ASTM D 792 | g/ee | 0.93 |
| Product Form | | | Dense Pellet |

⁽¹⁾Condition (200° C./5 kg).
⁽²⁾Typical values on compressions molded plaques, intended only as guides and should not be construed as specifications.
⁽³⁾1 sec. Dwell.

Other styrene-olefin block copolymers useful in the elastomeric composition include the styrene-polyolefin-styrene block copolymers shown in Table 3.

TABLE 3
STYRENE-POLY(ETHYLENE-PROPYLENE)-STYRENE
BLOCK COPOLYMER
Physical Properties

| | |
|---|---|
| Tensile Strength, psi | 2260 |
| 300% Modulus, psi | 740 |
| Elongation at Break, % | 550 |
| Stress Relaxation, % | 23 |
| Hysteresis Properties: | |
| Recoverable Energy, % | 77 |
| Set, % | 9 |

It may be desirable to blend the styrene-poly(ethylene-propylene)-styrene elastomeric copolymer with another elastomeric block copolymer such as styrene-poly(ethylene-butylene)-styrene block copolymer to form an elastomeric block copolymer mixture. Styrene-poly(ethylene-butylene)-styrene block copolymers may be obtained from the Shell Chemical Company under the trade designation KRATON® G-1652.

The ethylene-vinyl acetate copolymers (EVA) present in the elastomeric compositions have a vinyl acetate percentage by weight relative to the ethylene in the range of 15-40 percent by weight. The term “ethylene-vinyl acetate copolymer” includes both the dipolymers and the terpolymers of ethylene with vinyl acetate and with carbon monoxide. Most commercial EVA dipolymers contain about 2-55 percent by weight of vinyl acetate. Terpolymers of ethylene with vinyl acetate and with carbon monoxide may contain about 18-40 percent by weight of vinyl acetate and 2-12 percent by weight of carbon monoxide. Polymers of ethylene with vinyl acetate are available from the E.I. DuPont de Nemours and Company, under the trademark Elvax®.

The maleic anhydride-olefin copolymers present in the elastomeric compositions include EXXELOR-VA 1803 from Exxon Mobile Co. Exxelor VA 1803 is a high flow, amorphous ethylene copolymer functionalized with maleic anhydride by reactive extrusion. Its fully saturated backbone results in outstanding thermal and oxidative stability leading to enhanced weatherability. Moreover, its amorphous nature exhibits impact resistance at very low temperatures in blends with other polymers. Properties of EXXELOR-VA 1803 are shown in Table 4.

TABLE 4

| | Exxon Mobile Test | | Exxelor |
|---|---|---|---|
| Property | Method (based on) | Unit | VA 1803 |
| Maleic anhydride | FTIR EPK-04 QT-02 | | High (*) |
| graft level | | | |
| Melt flow rate | ASTM D 1238 | g/10 min | 3 |
| (2.16 kg/230° C.) | | | |
| Melt flow rate | ASTM D 1238 | g/10 min | 22 |
| (10 kg/230° C.( | | | |
| Density | DIN 53479 | g/cm3 | 0.66 |
| Glass transition | DSC | ° C. | −57 |
| temperature (Tg) | | | |
| Volatiles | AM-S 350.03 | % | 0.15 max. |
| Color | ASTM E 313-96 | Yellowness | 25 max |
| | | Index Pellet | |

(*) MA level is typically in the range of 0.5 to 1.0 wt %.
The values indicated in the table describe typical properties but do not constitute specification limits.

The phenolic resins present in the elastomeric compositions can be obtained from Schenectady International as SP-1045. The properties of these resins are given in Table 5. SP-1045 Resin is a heat reactive octylphenol-formaldehyde resin which contains methylol groups. It was specifically designed for the cure of isobutylene-isoprene (Butyl) rubber by the resin cure system. The octyl group makes SP-1045 Resin compatible with elastomers, and can yield mixtures offering a wide range of properties. In addition, they methylol groups can be used as functional sites for a variety of reactions.

TABLE 5
SPECIFICATIONS

| Property | Min. | Max. | Test Method |
|---|---|---|---|
| Melting Point, Capillary, (° F.) | 140 | 150 | T06M01.01 |
| Softening Point, B&R, (° C.) | 80 | 95 | T06M02.01 |
| Methylol Content (%) | 8 | 11 | T17M01.02 |
| Color, Gardner, 64% in Toluene | 1 | 6 | T04M01.03 |

Other phenolic resins useful in the elastomeric compositions include the Novalac resins. Novalac resins are described in the Encyclopedia of Polymer Science and Engineering, Volume 11, pages 45-95 (1985).

While the principal components of the extrudable elastomeric compositions used to form the elastic articles have been described, said extrudable elastomeric compositions are not limited and can include other known components which do not adversely affect the extrudable elastomeric composition. Exemplary materials used as additional components include, pigments, antioxidants, stabilizers, surfactants, waxes, flow promoters, solvents, and materials added to enhance processability of the composition.

The compositions of this invention are melt processible using conventional plastic processing equipment. Elastic articles derived from the thermoplastic elastomeric compositions of the present invention exhibit properties generally associated with vulcanized rubber. There are various uses for the elastomeric compositions including the manufacture of automotive parts, sheets, liners, fibrous nonwoven fabrics, films and the like. The compositions can be used also to coat fabric, form other industrial articles such as laminates with various hard surfaces by extrusion on substrates of polyesters, polyamides, or polyimides. Preferably, the extrudable compositions can be formed into nonwoven webs by known extrusion techniques. A preferred extrusion technique is to form sheets, fibers or fibrous nonwoven elastomeric webs by meltblowing techniques.

The scope of the invention is indicated by the appended claims, rather than by the description, and all changes which come within the meaning and range of equivalents of the claims are intended to be embraced therein.

1. An elastomeric composition for the extrusion of elastic articles using an extensional flow mixer on the extruder which comprises from about 20 to 50 parts by weight of a polymer selected from the group consisting of a thermoplastic polyurethane and a polyolefin, 20 to 50 parts by weight of a styrene-olefin copolymer, 5.0 to 40 parts by weight of an ethylene-vinyl acetate polymer, 1.0 to 10 parts by weight of a maleic anhydride-olefin copolymer, and 0.0 to 3.0 parts by weight of a phenolic resin.

2. An elastomeric composition for the extrusion of elastic articles using an extensional flow mixer on the extruder which comprises from about 35 to 45 parts by weight of a polymer selected from the group consisting of a thermoplastic polyurethane and a polyolefin, 35 to 45 parts by weight of a styrene-olefin copolymer, 10 to 20 parts by weight of an ethylene-vinyl acetate polymer, 4.0 to 6.0 parts by weight of a maleic anhydride-olefin copolymer, and 0.1 to 2.0 parts by weight of a phenolic resin.

3. The elastomeric composition of claim 2 wherein the polymer is a thermoplastic polyurethane.

4. The elastomeric composition of claim 2 wherein the polymer is a lower molecular weight polyolefin.

5. The elastomeric composition of claim 2 wherein the composition is extruded into an elastic sheet.

6. The elastomeric composition of claim 2 wherein the composition is extruded into an elastic fibrous nonwoven fabric.

7. The elastomeric composition of claim 2 wherein the composition is extruded into elastic fibers.

8. The elastomeric composition of claim 4 wherein the polyolefin is polyethylene.

9. The elastomeric composition of claim 2 wherein the styrene-olefin copolymer is a styrene-ethylene copolymer.

10. The elastomeric composition of claim 2 wherein the maleic anhydride-olefin copolymer is a maleic anhydride-ethylene copolymer.

11. A process of preparing an elastic article by extruding an elastomeric composition using an extensional flow mixer on the extruder which comprises from about 20 to 50 parts by weight of a polymer selected from the group consisting of a thermoplastic polyurethane and a polyolefin, 20 to 50 parts by weight of a styrene-olefin copolymer, 5.0 to 40 parts by weight of an ethylene-vinyl acetate polymer, 1.0 to 10 parts by weight of a maleic anhydride-olefin copolymer, and 0.0 to 3.0 parts by weight of a phenolic resin.

12. The process of claim 11 wherein the elastomeric composition comprises from about 35 to 45 parts by weight of a polymer selected from the group consisting of a thermoplastic polyurethane, and a polyolefin, 35 to 45 parts by weight of a styrene-olefin copolymer, 10 to 20 parts by weight of an ethylene-vinyl acetate polymer, 4.0 to 6.0 parts by weight of a maleic anhydride-olefin copolymer, and 0.1 to 2.0 parts by weight of a phenolic resin.

13. The process of claim 12 wherein the polymer is a thermoplastic polyurethane.

14. The process of claim 12 wherein the polymer is a lower molecular weight polyolefin.

15. The process of claim 12 wherein the elastomeric composition is extruded into an elastic fibrous nonwoven fabric, having a permanent deformation less than 2.0 percent after 100% elongation.

16. The process of claim 12 wherein the elastomeric composition is extruded into an elastic sheet.

17. The process of claim 12 wherein the elastomeric composition is extruded in an extensional flow mixer attached to the end of the extruder forming an elastic article having a permanent deformation of less than 2.0 percent.

18. The process of claim 12 wherein the elastic article is a fibrous nonwoven fabric having tension set after 100% elongation of less than 2%.

19. The process of claim 12 wherein the elastic article is an elastic sheet having tension set after 100% elongation of 1.0 percent.

20. The elastic article obtained by the process of claim 12.
